(19) United States
(12) Patent Application Publication
(10) Pub. No.: US 2017/0292640 A1
(43) Pub. Date: Oct. 12, 2017

(54) Multi Seal Valve Stem Extension

(71) Applicant: William C. Falkenborg, Tujunga, CA (US)

(72) Inventor: William C. Falkenborg, Tujunga, CA (US)

(21) Appl. No.: 15/092,087

(22) Filed: Apr. 6, 2016

(51) Int. Cl. F16L 15/00; F16K 1/32

(52) U.S. Cl. CPC F16L 15/008; F16K 1/32

(57) ABSTRACT

A multi seal extension for an air valve (MSEFAV) that functions in combination with a conventional air valve having an air valve stem in order to extend the length of the stem, thus facilitating the insertion of air via the valve from a greater distance. The MSEFAV includes a rotating securement sleeve, an extension tube, and a stem interface. Inserted into, and attached to, the extension tube is the stem interface, which has multiple seals: a first, end of valve seal; a second, inner thread seal; and a third, core seal. The inclusion and use of the seals provides significantly increased air retention, and projection against moisture and dirt from entering the MSEFAV and air valve, over conventional valve extension designs.

### TECHNICAL FIELD

The invention generally pertains to air valves, and more particularly to an air valve extension that utilizes multiple seals to provide better and longer functional capability of the valve extension.

### BACKGROUND ART

In order to facilitate the use of pneumatic tires, an air valve, which is also known as a Shrader valve or an American valve, is required. An air valve allows air to be inserted into a tire to inflate the tire or to remove air to deflate the tire. In addition to tube and tubeless tires, air valves are also used on other high-pressure pneumatic systems, and the valve design can also be used for high pressure hydraulic systems.

An air valve typically consists of an externally threaded cylindrical tube, usually made of a metal such as brass. In the center of the exterior end is a metal pin directed along the longitudinal axis of the tube. Generally, the dimensions of the valves and threads are the same for all air valves in order to provide a single standard size.

Into an air valve's stem, a stem interface is threaded. The stem interface typically comprises a poppet valve that is assisted by a spring. Onto the end of an air valve, a rotating securement sleeve is attached, usually by threads, to keep dirt and moisture out of the valve.

Within an air valve there is usually one or two seals or O-rings. The seals/O-rings maintain the air passing through the valve and protects the valve from the unwanted intrusion of moisture and/or dirt. The seals/O-rings are placed to provide maximum efficiency, and although the seals/O-rings do perform adequately well, there can still be air leakage within a valve. For valves of greater length, or especially valve extensions, this problem is more prevalent. What is needed is a valve or valve extension that provides better internal sealing which would allow a valve or valve extension to function for a significantly longer time than current conventional valves.

A search of the prior art did not disclose any literature or patents that read directly on the claims of the instant invention. However, the following publication and U.S. patents are considered related:

| PAT. NO. | INVENTOR | ISSUED |
|---|---|---|
| 6,966,331 | Simmons et al | 22 Nov. 2005 |
| 8,371,554 | Beswick et al | 12 Feb. 2013 |
| 2014/0183393 | Hunter et al | 3 Jul. 2014 |

The U.S. Pat. No. 6,966,331 patent discloses a valve stem adaptor for a valve stem assembly having a body with a first end and a second end. The valve stem adaptor includes an adaptor body manufactured from a rigid material and has an adaptor rim portion with an upper surface, lower surface and passageway extending through the adaptor body. The valve stem adaptor also includes a first O-ring adapted to fit adjacent an upper surface of the adaptor rim portion, and a second O-ring adapted to fit adjacent a bottom surface of the adaptor rim portion.

The U.S. Pat. No. 8,371,554 patent discloses a stem-actuated two-way valve for intermittent and repeatable delivery of fluid and/or gaseous substances from high pressure sources. A dual purpose O-ring functions as a valve seat and separates high pressure segments from low pressure segments. The valve stem system allows precise delivery of desired liquids and/or gases regardless of valve stem travel within a defined travel length.

The 2014/0183393 publication discloses a gate valve for sue in oil field applications and includes a stem seal assembly. The stem seal assembly includes primary, secondary, and tertiary seals for sealing the space between the stem and the bonnet. The provision of multiple seals in the stem seal assembly provides redundancy that allows for maintenance of the seal between the components.

For background purposes and indicative of the art to which the invention relates, reference may be made to the following remaining patents found in the patent search.

| PAT. NO. | INVENTOR | ISSUED |
|---|---|---|
| 2,008,096 | Clo | 16 Jul. 1935 |
| 2,122,740 | Eckenroth | 5 Jul. 1938 |
| 2,813,567 | Williams | 19 Nov. 1957 |
| 2,854,020 | Williams | 30 Sep. 1958 |
| 3,556,474 | Scaramucci | 19 Jan. 1971 |
| 3,601,420 | Binford | 24 Aug. 1971 |
| 3,608,912 | Templin | 28 Sep. 1971 |
| 4,445,527 | Leimbach | 1 May 1984 |
| 4,695,061 | Meisner et al | 22 Sep. 1987 |
| 4,826,180 | Deuring | 2 May 1989 |
| 4,915,125 | Lester | 10 Apr. 1990 |
| 5,016,668 | Nicolino et al | 21 May 1991 |
| 5,237,971 | Worsley | 24 Aug. 1993 |
| 5,927,685 | Gosling | 27 Jul. 1999 |
| 6,932,354 | Kane et al | 23 Aug. 2005 |
| 7,900,932 | Leimer et al | 8 Mar. 2011 |
| 8,840,085 | Choo et al | 23 Sep. 2014 |
| 8,967,182 | Tigges | 3 Mar. 2015 |
| 2006/0175567 | Chan et al | 10 Aug. 2006 |
| 2013/0082203 | Kurth et al | 4 Apr. 2013 |
| 2013/0200574 | Hegemier et al | 8 Aug. 2013 |
| 2014/0175319 | Bell | 26 Jun. 2014 |
| 2014/0183392 | Hunter et al | 3 Jul. 2014 |

### DISCLOSURE OF THE INVENTION

In its basic design, the multi seal extension for an air valve (MSEFAV) functions in combination with a conventional air valve having a threaded stem, in order to extend the length of the stem, thus facilitating the insertion of air via the valve from a greater distance.

The MSEFAV essentially comprises a rotating securement sleeve, an extension tube and a stem interface. Inserted into and attached to the extension tube is the stem interface which has three seals: a first, end of valve seal; a second, inner thread seal; and a third, core seal. The use of three seals is a significant improvement over conventional valve extension designs which only have one or two seals.

The MSEFAV is attached onto air valve and secured thereto by corresponding sets of threads on an inner surface of the rotating securement sleeve and an outer surface of the air valve stem. Once the MSEFAV is secured onto the air valve stem, the seals function in combination to provide an extension with a hermetic seal between the MSEFAV and the air valve stem.

In view of the above disclosure, the primary object of the invention is to provide a multi seal extension for an air valve that offers a significant functional improvement over current conventional air valve extensions.

In addition to the primary object, it is also an object of the invention to provide a multi seal extension for an air valve that:
is both air-tight and water-tight,
can be effectively used for a longer duration than other conventional air valve extensions,
can be made in various lengths,
can be used for various purposes,
is especially effective for use with extra wide tires and wheels,
is easy to attach and remove
is durable can be sold as an OEM product or an after-market product, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic exploded view of a multi seal extension for an air valve (MSEFAV).

FIG. 2 is a side elevational exploded view of the MSEFAV.

FIG. 3 is an orthographic view of the MSEFAV prior to being attached to an air valve stem.

FIG. 4 is an orthographic view of the MSEFAV's stem interface.

FIG. 5 is an orthographic view of the MSEFAV's rotating securement sleeve having multiple flat surfaces around the cap's perimeter.

FIG. 6 is an orthographic view showing the MSEFAV with the rotating securement sleeve slid down to the end of the extension tube, prior to attachment on an air valve stem.

FIG. 7 is an elevational exploded view of a second/alternate embodiment of the MSEFAV that utilizes a dual seal rotating securement sleeve which is transformed into a multi seal rotating securement sleeve during attachment.

### BEST MODE FOR CARRYING OUT THE INVENTION

The best mode for carrying out the invention is presented in terms that disclose a preferred embodiment of a multi seal extension for an air valve. The use of an extension on an air valve, which is also known as a Shrader valve or an American valve, is a common practice when an air valve stem is situated at a location which presents difficult accessibility. Both air valves and valve extensions are well known in the art and have long been in use.

Air valves are generally made in a standard diameter, and most conventional valve extensions are designed to screw onto an air valve stem. The length and shape of an extension are determined by the requirement of a particular application. Most valve extensions have one or two seals, usually consisting of washers or O-rings. While one or two seal(s) do perform adequately well for the intended purpose of maintaining air within the extension, and keeping moisture and dirt from entering, in certain cases problems relating to the seals can arise. The multi seal extension for an air valve (MSEFAV 10) solves the problems by adding additional seals which significantly improve the MSEFAV's 10 air retention, as well as protection from moisture and dirt.

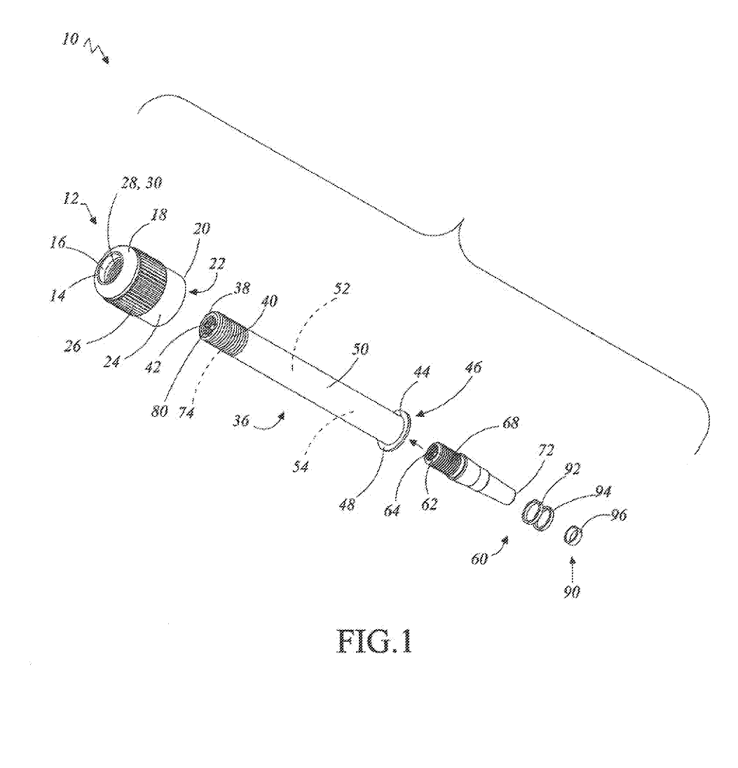

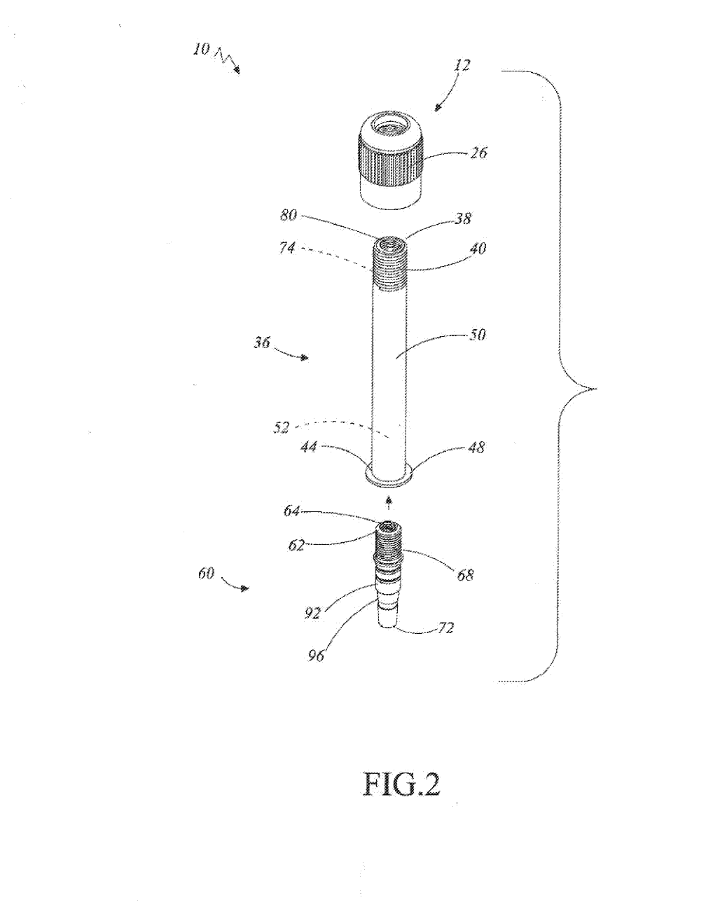

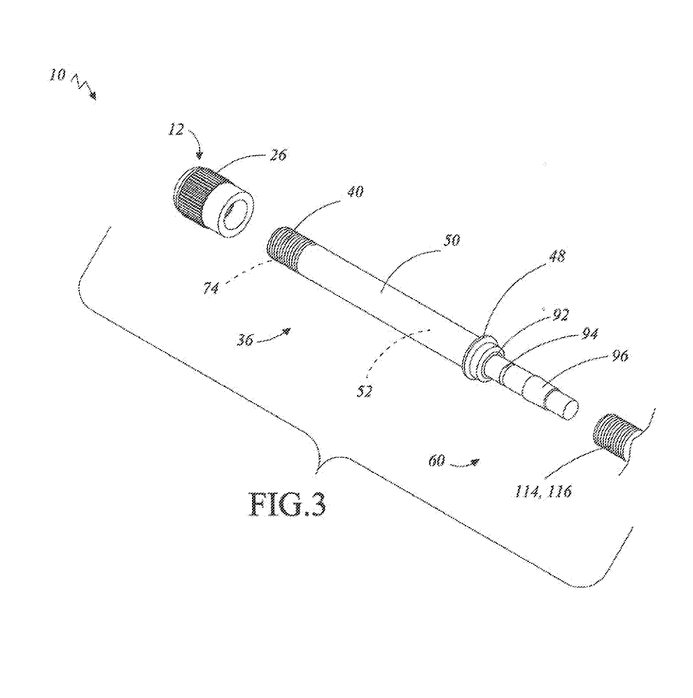

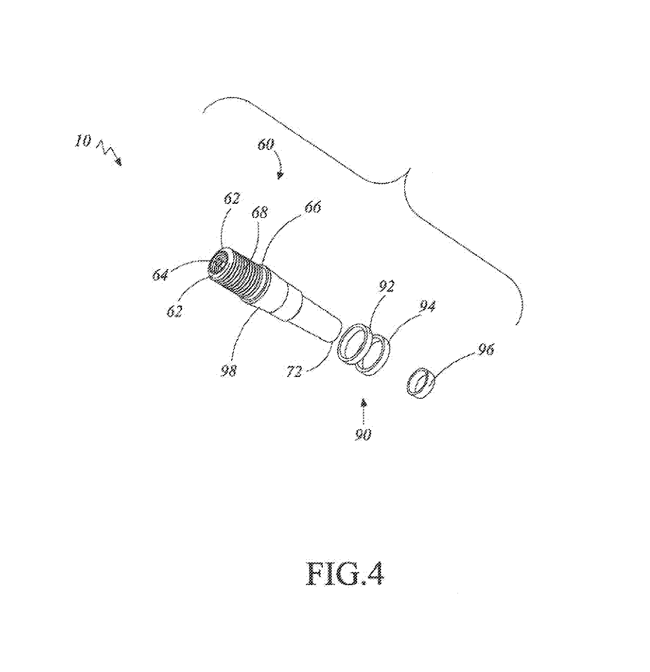

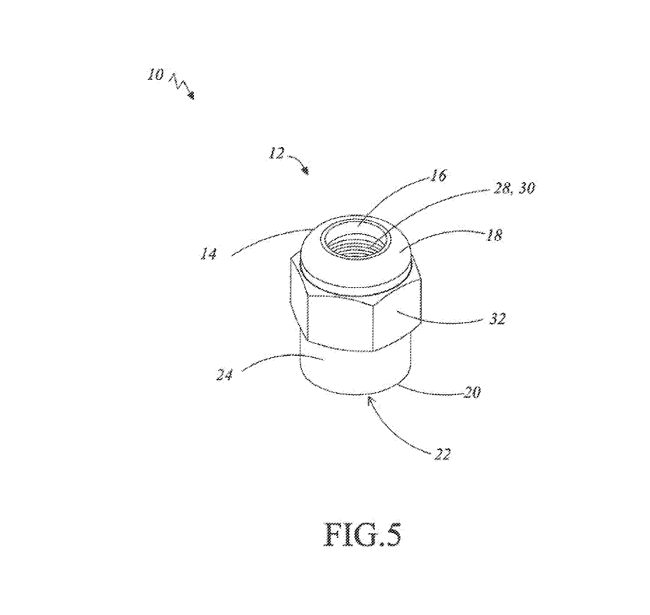

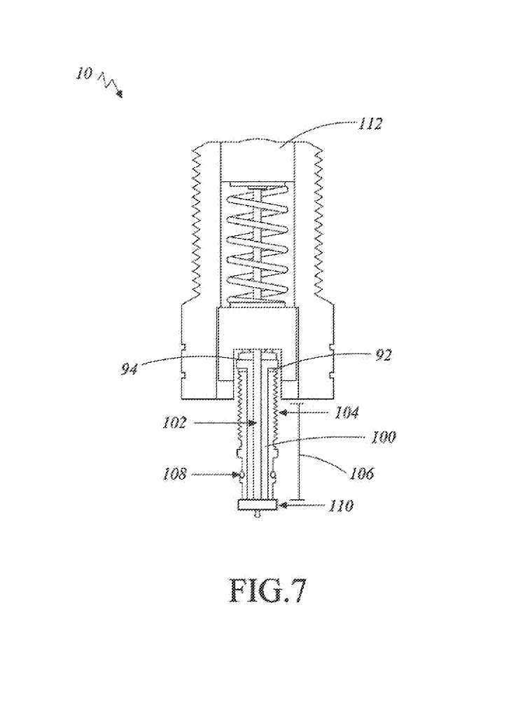

The MSEFAV 10 as shown in FIGS. 1-7, is comprised of the following major elements: a rotating securement sleeve 12, an extension tube 36, and a stem interface 60 having a multi core seal assembly 90. It is important to note that all the major elements are well known in prior art, with the inventive element being the use of multiple seals on the stem interface 60. All the elements of the MSEFAV 10, except for the actual seals, are made of metal, with brass preferred. The rotating securement sleeve 12, as shown in FIGS. 1, 3 and 5, is comprised of a first end 14 having an opening 16 and a domed edge 18, a second end 20 having an opening 22, an outer surface 24 with gripping ridges 26, and a threaded inner surface 28. As shown in FIGS. 1 and 3, the gripping ridges 26 consist of a plurality of parallel ridges that are located around the perimeter of the cap's outer surface 24. Additionally, other designs can also be utilized, such as multiple flat surfaces 32 around the outer surface 24, as shown in FIG. 5.

The extension tube 36, as shown in FIGS. 1-3, is comprised of a threaded 40 first end 38 having an opening 42, a second end 44 having an opening 46 with an outward-extending flange 48, an outer surface 50, and an inner surface 52 with a threaded section 54. The extension tube 46 is dimensioned to allow the rotating securement sleeve 12 to be slideably inserted onto the tube 36 via the opening 16 on the cap's first end 14 which slides over the tube's first end 38. The extension tube 36 has a length that ranges from 1-inch to 10-inches. Located within the first end 38 of the tube 36 is an inner core structure 74 comprising a valve pin 80. The valve pin 80 is actuated, usually by a spring, to facilitate the insertion or removal of air through the extension tube 36 and into the air valve.

The stem interface 60, as shown in FIGS. 1-4 and 6, is comprised of a first end 62 having an opening 64, an upper section 66 that extends from the first end 62 and having outer threads 68 and inner threads 70, and a second end 72. The first end 62 and upper section 66 are inserted into the extension tube 36 via the opening 46 on the tube's second end 44. The outer threads 68 on the upper section 66 mate with the threaded section 54 on the tube's inner surface 52, thereby securing the stem interface 60 to the extension tube 36.

Located on the stem interface 60 is the multi core seal assembly 90. As shown in FIGS. 1-4 and 6, the seal assembly 90 comprises three individual seals: a first, end of valve seal 92; a second, inner thread seal 94; and a third, core seal 96. Preferably, the first seal 92 is comprised of a washer, the second seal 94 is comprised of an O-ring, and the third seal 96 is comprised of a washer. Typically, the washer(s) are wider than the O-ring. The three seals are each made of a material selected from the group consisting of plastic, rubber, nylon or another resilient material. Additionally, as shown in FIGS. 1-4 and 6, the stem interface includes an outward-extending taper 98 that is located between the first seal 92 and the second seal 94. During attachment of the MSEFAV 10 to an air valve, the second inner thread seal 94 is forced upward to the taper 98. As the seal 94 interfaces with the taper 98, the seal's 94 diameter expands, thereby creating an increase in the sealing functionality.

When the MSEFAV 10 is secured onto an air valve via the air valve stem 114, the three seals 92,94,96 function in combination to provide a valve stem extension with a hermetic seal between the MSEFAV 10 and the air valve stem 114. The MSEFAV 10 is attached to an air valve stem by initially removing the valve cap 118 and stem interface from an existing air valve stem 114. The MSEFAV 10 is then secured onto the air valve stem 114 by sliding the rotating securement sleeve 12 down the extension tube 36 and onto the valve stem 114, which engages and mates the threads on the cap's inner surface 28 to the threads 104 on the air valve stem 114. After attachment, the valve rotating securement sleeve 12 can then be screwed onto the extension tube 36 thus securing the MSEFAV 10 to the air valve.

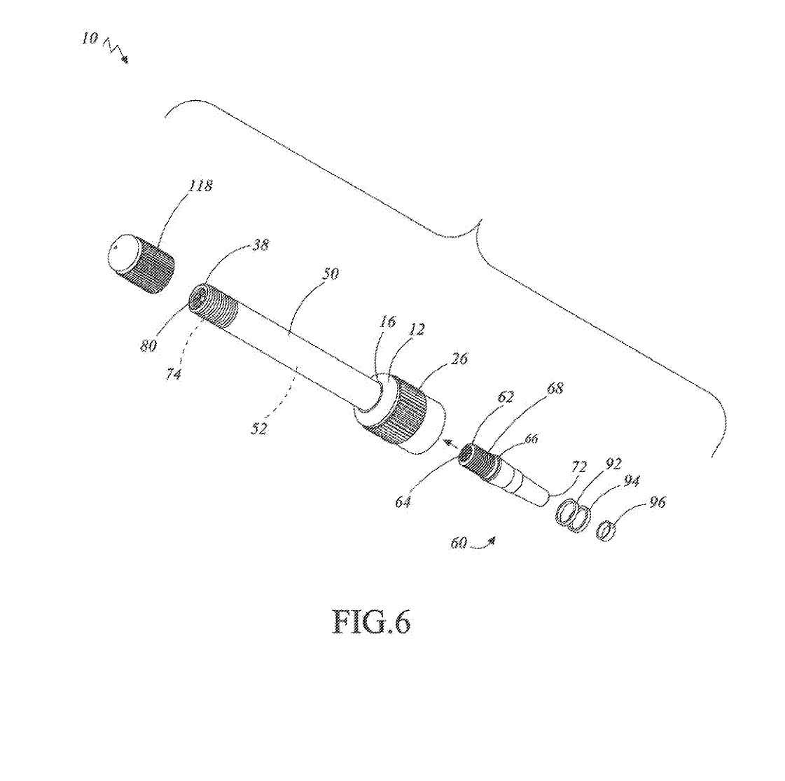

In an alternate embodiment, an air valve design that utilizes a plunger 100 at the lower end with a centrally-located pin 102, an end seal 112, and external core seal threads along a core seal shaft 106. By using the plunger, the second/alternate embodiment can be likened to a “trap door” type of design. In the second/alternate embodiment, as shown in FIG. 6, a core clip seal 108, an end seal 112 and a plunger seal 110 are used. When the valve extension is attached onto an air valve stem, a dual seal rotating securement sleeve transforms into a multi seal cap, thereby providing secure hermetic attachment of the valve extension onto the air valve stem. It is important to note that the first embodiment, as initially disclosed herein, is for constant pressurized (or live) use, while the second alternate embodiment is only pressurized when actuated by pressing downward on the valve extension's end.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A multi seal extension for an air valve (MSEFAV) attached to an air valve stem to extend the length of the stem, wherein said MSEFAV is comprised of a rotating securement sleeve and an extension tube into which a stem interface is inserted, wherein said stem interface having three seals: a first seal comprising an end of valve seal, a second seal comprising an inner thread seal, and a third seal comprising a core seal, wherein said MSEFAV is attached onto an air valve stem and secured thereto by corresponding sets of threads on an inner surface of said rotating securement sleeve and an outer surface of the air valve stem, wherein once said MSEFAV is secured onto the air valve stem, said three seals function in combination to provide an extension with a hermetic seal between said MSEFAV and the air valve stem.

2. The multi seal extension for an air valve as specified in claim 1 wherein said MSEFAV is made of metal.

3. The multi seal extension for an air valve as specified in claim 2 wherein the metal is brass.

4. The multi seal extension for an air valve as specified in claim 1 wherein said MSEFAV has a length ranging from 1-inch to 10-inches.

5. The multi seal extension for an air valve as specified in claim 1 wherein the air valve is comprised of a metal TR-500 series valve.

6. The multi seal extension for an air valve as specified in claim 1 wherein said first, end of valve seal is comprised of a washer.

7. The multi seal extension for an air valve as specified in claim 1 wherein said second, inner thread seal is comprised of an O-ring.

8. The multi seal extension for an air valve as specified in claim 1 wherein said third, core seal is comprised of a washer.

9. A multi seal extension for an air valve (MSEFAV) attached to an air valve stem to extend the length of the stem, wherein said MSEFAV is comprised of:
a) a rotating securement sleeve with a first end having an opening and a domed edge, a second end having an opening, an outer surface with gripping ridges, and a threaded inner surface,
b) an extension tube with a threaded fust end having an opening, a second end having an opening with an outward extending flange, and an outer surface, and an inner surface with a threaded section, wherein said extension tube is dimensioned to allow said rotating securement sleeve to be slideably inserted onto said tube via the opening on said rotating securement sleeve's first end which slides over said tube's first end, and traverses the tube from the first end to the second end, wherein within the first end is a valve core including a valve pin that facilitates the insertion or removal of air through said extension tube,
c) a stem interface with a first end having an opening, an upper section that is extends from the first end and having outer threads and inner threads, and a second end, wherein the first end and upper section is rotatably inserted into said extension tube via the opening on said tube's second end, and the outer threads on said stem interface's upper section mate with the threaded section on said tube's inner surface, thereby securing said stem interface to said extension tube, and
d) a multi core seal assembly that is located on said stem interface and comprises:
(1) a first, end of valve seal,
(2) a second, inner thread seal and,
(3) a third, core seal,
wherein, when said MSEFAV is secured onto an air valve via the air valve stem, said seals function in combination to provide a valve stem extension with a hermetic seal between said MSEFAV and the air valve stem, wherein to use said MSEFAV, a valve cap and end core interface from an existing air valve are removed, the threaded second end of said stem interface extending from said extension rube is inserted and screwed into a threaded opening that is created on the existing air valve by the removal of the existing air valve's end core, wherein said MSEFAV is then secured onto the air valve stem by placing said rotating securement sleeve onto the stem and rotating said rotating securement sleeve which engages and mates the threads on said cap's inner surface to the threads on the air valve stem.

10. The multi seal extension for an air valve as specified in claim 9 wherein said MSEFAV is made of metal.

11. The multi seal extension for an air valve as specified in claim 10 wherein the metal is brass.

12. The multi seal extension for an air valve as specified in claim 9 wherein said MSEFAV has a length ranging from 1-inch to 10-inches.

13. The multi seal extension for an air valve as specified in claim 9 wherein the air valve is comprised of a metal TR-500 series valve.

14. The multi seal extension for an air valve as specified in claim 9 wherein said first, end of valve seal is comprised of a washer.

15. The multi seal extension for an air valve as specified in claim 9 wherein said second, inner thread seal is comprised of an O-ring.

16. The multi seal extension for an air valve as specified in claim 9 wherein said third, core seal is comprised of a washer.

17. The multi seal extension for an air valve as specified in claim 9 wherein said three seals are each made of a resilient material.

18. The multi seal extension for an air valve as specified in claim 9 wherein said stem interface further comprises an outward extending taper that is located between said first seal and said second seal, wherein during attachment of said MSEFAV to an air valve, said second, inner thread seal is forced upward to said taper, wherein as said seal interfaces with said taper, said seal's diameter expands, thereby creating an increase in the sealing functionality.
